(19) United States
(12) Patent Application Publication
(10) Pub. No.: US 2015/0108280 A1
(43) Pub. Date: Apr. 23, 2015

(54) Mechanism for stabilizing and creating a variable gravitational field in a toroidal space station

(71) Applicant: Harold James Willard, JR., Washington, DC (US)

(72) Inventor: Harold James Willard, JR., Washington, DC (US)

(21) Appl. No.: 13/998,284

(22) Filed: Oct. 18, 2013

(51) Int. Cl. B64G 1/10; B64G 1/66; B64G 1/46

(52) U.S. Cl. CPC B64G 1/10; B64G 1/46; B64G 1/66
USPC 244/171.9

(57) ABSTRACT

This invention provides a mechanism to create an artificial gravitational environment in a toroidal space station in which gravity may vary from zero, of advantage during repairs, manufacturing and research activities, and docking maneuvers, to values greater than one g for preparing astronauts for missions to other planets, or for other purposes. The mechanism couples the rotation of a high density cylinder in the center of the hub to that of the torus through gears such that the total angular momentum of the station is zero, allowing maneuvering of the station to be less complicated since gyroscopic effects are eliminated, and the level of gravity in the torus to be varied without the use of external thrusters. Gears are driven by motors attached to the hubs, providing redundancy for maintenance and emergency operations, with power provided by solar cells, a nuclear power plant, or other means.

### REFERENCE TO PRIOR APPLICATION

Application Ser. No. 12/929,471, Conf. No. 5791, “Rotating space station torque eliminator”; rejected by USPTO June 2013.

### REFERENCES CITED

1. Neufield, Michael J., Von Braun, Dreamer of Space, Engineer of War, Vintage Books, N.Y., 2007.

### U.S. Patent Documents

2. U.S. Pat. No. 2,973,162A; February-1961; W. Haeussermann
3. U.S. Pat. No. 3,144,219A; August-1964; E. Schnitzer
4. U.S. Pat. No. 3,216,674A; November-1965; W. B. McLean
5. U.S. Pat. No. 3,300,162A; January-1967; O. E. Maynard, et al.
6. U.S. Pat. No. 3,437,286A; May-1969; Charles A. Lindley
7. U.S. Pat. No. 3,471,105; October-1969; G. W. Yarber and K. T. Chang
8. U.S. Pat. No. 3,511,452A; May-1970; Cleon L Smith, et al.
9. U.S. Pat. No. 3,675,379A; July-1972; Harry B. Fuchs
10. U.S. Pat. No. 3,758,051A; September-1973; Donald D. Williams
11. U.S. Pat. No. 4,739,797A; March-1988; Michael A. Minovitch
12. U.S. Pat. No. 6,645,094A; April-2000; Ramon L. Rivera
13. U.S. Pat. No. 6,206,328B1; March-2001; Thomas C. Taylor
14. U.S. Pat. No. 6,216,984B1; April-2001; Akbar F. Brinsmade
15. U.S. Pat. No. 7,290,737B2; November-2007; Rader, et al.

### Foreign Patent Documents

16. JP 03038500; February-1991; Japan; Masahito Nakano

### BACKGROUND OF THE INVENTION

(1) Field of the Invention

The present invention relates to a rotating toroidal-type space station. In particular, to a mechanism for producing a variable artificial gravitational environment in such a station using a mechanical system in the hub comprised of gears, and a counter-rotating, high-density cylinder selected to produce zero angular momentum for the station.

(2) Description of the Prior Art

Each species is endowed with characteristics needed to ensure its survival in a competitive environment with its own kind and with members of other species, subject to the laws of nature. Apparently only man is unique among all species in his ability to recognize his existence and to discern natural laws and make use of them. In this capacity, he has the responsibility to use this special knowledge to ensure not only the survival of his species, but others, as well.

Two manifestations of these special characteristics are evident in the behavior of children: their strong desire to explore the world about them—to question “Why?”; and their strong desire to make things move, to travel.

Planet Earth is only a spec in a hostile universe, subject to continual bombardment by debris, large and small, from space. An impact from a large meteor could destroy earth or, as has happened with the extinction of the dinosaurs, all higher forms of life on our planet. The Congress of the United States has recognized this danger and has passed legislation to initiate a study of the problem.

Response to such an event could best be met in a timely manner from an orbiting space station or a base on our moon.

Furthermore, if it should become necessary to abandon planet Earth from this threat or because man has rendered our planet unfit for human habitation through wars or misuse of technology, an orbiting space station would most likely offer the quickest and the safest means for escape. It would provide an interim step towards finding another home. Such a station, or multiple stations, would need to be large enough to house other creatures, in effect to be Noah's Ark, and to be international in scope.

Currently, man is taking the first steps into the exploration of space. Only individuals with exceptional physical, emotional, and intellectual aptitudes are selected as astronauts and their responses to the new environment are intensely studied. It has been observed that the muscular and sketetal health of astronauts deteriorates with time in the absence of a gravitational field. To offset such effects, Werner von Braun, pioneering rocket designer for the United States in the 1950s, proposed a design for a rotating space station in which an artificial gravitational field is created via centrifugal force (Reference 1). FIG. 1 is a photo of a model of von Braun's concept, once on display in the Air & Space Museum, Washington, D.C. It includes a hollow torus connected by three spokes to a central hub, about which the torus rotates.

A problem associated with such a design is the need to provide an external torque to initiate and control the rotation. The use of small rocket engines requires that fuel be provided to operate the rockets, which must now be transported from earth, a costly and time consuming activity, which could be hazardous in times of emergency.

However, with the present invention, external rocket engines are not required to rotate the station. Instead, electrical motors attached to a flywheel and gearing system within the hub are used, which can be powered by solar cells attached to the station, or externally through a microwave transmission system, or by other means, such as a nuclear power plant. The mechanical system within the hub is designed to produce a zero overall angular momentum for the station by coupling and controlling the rotation of the flywheel in a direction opposite to that of the torus. With zero net angular momentum, orientation of the station becomes much simpler since gyroscopic effects are eliminated and therefore the station does not precess with the application of a torque about the center axis.

Having a variable gravitational field in the torus offers scientific and engineering advantages. Scientific research on the effects of gravity on living and non-living systems from zero gravity to that exceeding that of earth can be pursued in preparation for exploration of other planets and in order to more fully understand such effects. Being able to stop rotation of the station easily could be especially beneficial for performing maintenance on the station, or for emergency conditions.

Although the operation of nuclear power plants on earth, and the storage and protection of high level radioactive waste, poses extraordinary dangers to humanity, such facilities could be operated in space with adequate shielding and distance from the space station. Such plants could be disposed of by sending them into the sun in the event of an accident or other emergency or at the ends of their useful lives. Similar considerations also apply to research facilities in space on substances too dangerous to be on earth (e.g. viruses).

### Discussion of Related Inventions

In the patent granted to Haeussermann (2, 1961), an attitude control system for space vehicles is conceived which uses internal reaction exerted on a rotary mass iso a space vehicle to turn the vehicle about an axis in order to absorb undesirable angular momentum about the axis, and thereby control its attitude about the axis. It differs from the present invention in that the present invention is not to control the attitude of a vehicle, but rather to create a variable artificial gravity environment within a space station.

Schnitzer's invention (3, 1964) creates a manned space station capable of being foldably stored in the payload stage of a multistaged rocket, launched into planetary orbit, and then self-erected. Artificial gravity may be created when the space station is in a condition of gravitational and centrifugal equilibrium. However, small reaction motors are used to initiate and control rotation to produce artificial gravity, with the disadvantage that fuel is required to operate the motors, not required in the present invention.

McLean (4, 1965) presents a navigation system for a body spinning in space about an axis along its direction of travel. In the present invention, the direction of travel will most likely be perpendicular to the direction of the spin axis of the station, but is not limited to such. Furthermore, reaction jets are used in McLean's invention to control the rotation, requiring the use of expendable fuel, not required in the present invention.

In the radial module space station patented by Maynard, et al (5, 1967), a space station is rotated about its hub axis to provide stability and produce artificial gravity in its modules. However, spin rockets are specified for rotating the station, suffering from the same disadvantage as noted above (i.e. that fuel must be provided to operate the rockets), not required for the present invention.

Lindley's space vehicle spin control system (6, 1969) uses a series of weights whirled at the end of a long, flexible cable rotatable about a space vehicle's center of gravity to create an artificial gravitational environment in a large manned space station. A primary purpose of this light weight system is to overcome the power and weight requirements of a flywheel system. However, this system requires a balance of the motion of the two cables. If either is broken or significantly disturbed, it is evident that instability can result and possibly a serious threat to the success of the mission. The additional power and weight requirements of the flywheel system in the present invention is a reasonable price to pay for increased reliability. The use of gears is a proven technology on Earth and in space. The use of centrifugal whirling masses is as yet unproven in space.

The stabilizer control system of Yarber, et al (7, 1969) uses a gimballed momentum, wheel mechanism to provide the stabilizing force to reduce to zero the wobble of a space vehicle. Such a system may be required in addition to a system for producing artificial gravity. It is not in competition with the present invention.

In the invention of C. L. Smith and R. H. Van Vooren (8, 1970), space vehicle navigation and control is accomplished via a reaction wheel rotating at such a speed that the total rotary momentum of the wheel and the vehicle is essentially zero so that the satellite behaves as an inert (non-spinning) body. In such a state the satellite does not wobble in response to a control impulse and may be reoriented without precession. This invention uses an attitude sensor and control gas jets to measure spin axis orientation errors and apply control torques. Such a system is not intended to produce an artificial gravitational environment, the objective of the present invention, but may be used with the present invention to achieve its objectives.

The invention of H. B. Fuchs (9, 1972) produces an artificial gravitational force through electrostatic generators. An oppositely-turning rotor counters the torque reaction created by the rotor of the electrostatic generator. A particular advantage of this system claimed by the inventor is that electrostatic treatments decongest the body organs of humans. It seems unlikely that such a system will safely provide for artificial gravity up to one g, achievable with the present invention. If the therapeutic benefits of electrostatics are important, such a system could be incorporated in a space station employing the present invention.

D. D. Williams (10, 1973) developed a system for correcting the orbit of a spin-stabilized vehicle, such as a satellite, in order to dampen the nutations of the body so that greater gain may be realized from its antenna. This invention is not intended to produce an artificial gravity; however, it could augment the present invention in order to solve similar problems which may be encountered with the present invention, which also features a spin-stabilized vehicle, in an emergency during which the zero net momentum is disturbed.

Minovitch (11, 1988) has created a space station of the toroidal type which provides for artificial gravity by rotating the torus about a central hub. The torus has a 100 m radius, with minor axis of 2 m, similar in size and shape to that of the current invention. Attitude control is maintained by a “large attitude control moment gyro system mounted in the center of the torus' hub”. This gyro is also used to control the spin of the torus to produce artificial gravity. The station is constructed in space from high strength, low density, non-elastic Kevlar fabric, and is intended to provide living space for 150 to 200 crew members in an Earth-like artificial gravity environment. The present invention can augment this invention by providing a much simpler means for creating a variable artificial environment using gears and a flywheel rather than a large gyroscope. The present invention also has the added advantage of providing for redundancy in the means for driving the rotating hub, an added safety measure for the system, of primary importance to space systems. Furthermore, the range of artificial gravity in the present invention is from zero, for gravity-free experiments, to one g of Earth's gravity, or even beyond to simulate the gravitational fields of other planets in preparation for future manned spade travels.

In the space station created by Rivera (12, 2000), modules are rotated to produce artificial gravity up to one g using magnetic levitation provided by three electromagnetic bearing assemblies, each of which comprises a rotating inner ring within a stationary outer ring. Power is provided by on-board electricity rather than thrusters. It seems probable that this system would be much more difficult to assemble, operate and maintain reliably in space than the far less complex design of the present invention. Furthermore, it lacks the backup options provided by the present invention.

Taylor (13, 2001) creates an artificial gravity habitation torus from salvaged rocket debris. This system provides for only 20% of normal Earth gravity, rather than a full one g (or beyond) provided for by the present invention.

Brinsmade (14, 2001) provides for artificial gravity in two cylindrical units (“gravity modules”). The artificial gravitational force created is apparently perpendicular to the upright axes of the astronauts, rather than through their legs. It is not clear if the beneficial effects from this force would be sufficient to adequately support astronaut health for prolonged excursions, in contrast to the present invention.

Rader, et al (15, 2007) create a momentum exchange system in a rocket vehicle, which includes a flywheel similar to the concept of the present invention. However, Rader's system is designed to demise upon re-entry. It is not in competition with the present design which is intended to be permanent.

The method used by Nakamo (16, 1991) to create and control artificial gravity in space uses a plurality of space stations rotating inversely to each other. Such a system does not apply to a less complex toroidal ring station under consideration in the present invention.

### SUMMARY OF THE INVENTION

The primary purpose of this invention is to provide a mechanism which can be used in a toroidal space station to create an artificial gravitational environment in which astronauts can live and work, while avoiding the deleterious effects of weightlessness during extended missions in space. The system is also designed to allow the gravitational field to be adjusted from zero, which could be of advantage during docking maneuvers, for research and manufacturing activities, or other purposes, to values even greater than that of Earth's gravitational field, in preparation for missions to other planets.

The system couples the rotation of a high density cylinder in the center of the hub to that of the outer torus through gears such that the rotation of the cylinder is opposite to that of the torus and at such an angular velocity that the angular momentum of the station is zero. With zero angular momentum, manuvering of the station is less complicated since gyroscopic effects, which would ensue without the counter-rotating flywheel, are removed.

The system is driven through electric motors attached to each of the gears as a back-up safety measure for maintenance or emergency situations. A duplicate set of gears and motors located at the opposite opposite end of the hub could also perform this function, rotating in the opposite direction, to provide an additional margin of safety through redundancy.

Electrical power is provided from whatever source is used for the station, such as solar power or microwave transmission from a source separate from the station. If a nuclear power plant is used at the station, appropriate shielding can be provided to protect personnel and equipment. In the event of an accident or at the end of life, the nuclear facility could be jettisoned into the sun for disposal of the highly radioactive debris, which would be too dangerous to be returned to Earth.

Although the mass of the flywheel assembly in the hub is about one-third that of the torus, the extra margin of safety realized through simplicity and redundancy justifies the initial costs of transportation and materials required to construct the mechanism.

### DETAILED DESCRIPTION OF THE INVENTION

This invention is intended to support a rotating space station, which can be a complete toroid or one of a similar design with modifications for specific functions. For example, FIG. 4 also shows a toroidal type station, but with pods rather than a complete torus. Such pods could be research stations for conducting studies on materials considered too dangerous to be on Earth, such as certain bacteria or viruses or highly toxic chemicals. At the end of design life or in the event of an emergency, such pods could be jettisoned into the sun for disposal.

FIG. 1 is a schematic of the space station of FIG. 1. With a mean radius (Rₛ) of the toroidal ring of 50M, the angular velocity required to produce an equivalent gravitational acceleration in the torus equal to k·g is

$$\begin{matrix}{ω}_{s} = \sqrt{k \cdot g / {R}_{s}} \\ = 0.433 \sqrt{k} rad \text{/} s \\ = 4.23 \sqrt{k} rpm\end{matrix} \qquad Eqn . ( 1 )$$

Here g is Earth's gravitational acceleration (9.8M/s²). k is a constant representing the fraction of Earth's acceleration to be achieved. If k=1, Earth's gravity is simulated. For k>1, a gravitational acceleration greater than that of Earth's is to be realized, perhaps in preparation for extended missions to other planets or to support experimental studies on the effects of gravity on human health. Such studies, for example, might reveal that spending a short time in an environment in which k>1 could significantly increase the time allowable for existence in a weightless environment.

The condition for equilibrium of the station is that the angular momentum ( J̅ₛ) of the torus, spokes, gears and shell of the hub about the axis of rotation be equal and opposite to that of the rotating flywheel ( J̅_{c}) (cylinder) within the hub. When this condition is reached, the total angular momentum of the station is zero and the station can be oriented much easier with an external torque about the axis since precession is eliminated, and artificial gravity is created without having to use external rocket motors. Thus,

$$\begin{matrix}\begin{matrix}\overline{T} = \frac{d}{d t} ( {\overline{J}}_{s} + {\overline{J}}_{c} ) \\ = 0\end{matrix} \\ and & Eqn . ( 2 ) \\ {\overline{J}}_{s} = - {\overline{J}}_{c} & Eqn . ( 3 )\end{matrix}$$

J̅ₛ is given by the sum of the products of the moments of inertia of the components and personnel about the center axis and the angular velocity of the torus. Although these moments of inertia are complicated and must be computed in detail in a final design for a particular station configuration and also during operation of the station, for the present analysis it is sufficient to assume that all of the mass, without the flywheel, is in the outer ring and that it is composed of a solid material of density about twice that of water (2E3 KG/M³). The angular momentum is, therefore,

| J̅ₛ|=mₛ·Rₛ² Eqn. (4)

in which mₛ, the mass of the torus is

$$\begin{matrix}{m}_{s} = {ρ}_{s} \cdot 2 π {R}_{s} \cdot π {R}_{o}^{2} \\ = 2.42 E 7 KG\end{matrix} \qquad Eqn . ( 5 )$$

Rₒ is the radius of the cross-section of the torus, which is estimated to be 3.5M, sufficient to provide room for a floor, equipment and reasonably comfortable living room for astronauts and their families.

The angular momentum of the torus for K=1, corresponding to Earth's gravity, is

$$\begin{matrix}\vert {\overline{J}}_{s} \vert = {I}_{s} \cdot {ω}_{s} \\ = {m}_{s} \cdot {R}_{s}^{2} \cdot {ω}_{s} KG {M}^{2} \text{/} s \\ = 2.68 E 10 KG \cdot {M}^{2} \text{/} s\end{matrix} \qquad Eqn . ( 6 )$$

In this invention, the counteracting angular momentum vector is created by rotating a high density cylinder about the axis of the station in a direction opposite to the rotation of the outer ring through a system of gears located in the hub, shown schematically in FIG. 3. It is understood that a final system will require bearings, shafts, supports and other devices, as is common in the field for space operations, as well as variable speed motors, powered by a source affixed to the station or otherwise configured to supply the necessary electrical power for the system. However, it will not be necessary to have external rocket motors to maintain the condition of artificial gravity within the torus.

The cylindrical flywheel (4) is attached to the central shaft through the supporting structure (5). To minimize its size, it is made of very high density metal, such as uranium, tungsten or tantalum, which have densities about twenty times that of water and about three times that of steel. However, these metals are difficult to fabricate and it is likely that the flywheel will have to be encased in a support structure of steel or titanium.

A limitation on the allowable angular velocity of the flywheel exists through the maximum allowable stress in the structure encasing it. This stress is given approximately by

σₜ=ρ_{c}·R_{c}²·ω_{c}² Eqn. (7)

in which ρ_{c} is the density of the cylinder, R_{c} is the radius of the supporting structure (i.e. outer radius of the cylinder), and ω_{c} is the angular velocity of the cylinder/flywheel. A conservative estimate for this stress is 2E8 N/M² (29,000 psi), about one quarter to one fifth that of the yield strength of high strength steel or titanium.

From Eqn. (7),

$$\begin{matrix}{R}_{c} \cdot {ω}_{c} = \sqrt{\frac{{σ}_{t}}{{ρ}_{c}}} \\ = 1 E 2 M \cdot rad \text{/} s\end{matrix} \qquad Eqn . ( 8 )$$

For a cylinder of radius 10M, the angular velocity is, from Eqn. (8), equal to 31.6 rad/s (302 rpm).

To determine the wall thickness of the cylinder, Eqn. (3) yields

I_{c}·ω_{c}=Iₛ·ωₛ Eqn. (9)

From Eqns. (3) and (6),

ρ_{c}·2πR_{c}·ΔR_{c}·L·R_{c}²·ω_{c}=2.68E10 KG M² rad/s Eqn. (10)

Assuming a cylinder length of 10M, ΔR_{c}, the wall thickness of the cylinder is 0.67M.

To determine the sizes of gears required to produce a rotation of 4.23 rpm in the ring/torus and 302 rpm in the flywheel/cylinder in the opposite direction, consider FIG. 3, in which R₁, R₂, R₃ are the radii of the pinion (1), intermediate (2), and ring (3) gears, respectively, and ω₁, ω₂, ω₃ are the corresponding angular velocities. Since the pinion (1) is affixed to the cylinder (4), ω₄=ω_{c}. Ring gear (3) is part of the hub, therefore, ω₃=ωₛ, which determines the radius of the pinion, if R₃, the radius of the ring gear affixed to the hub is specified. Assuming that R₃=12M,

$$\begin{matrix}{R}_{1} = \frac{{ω}_{s}}{{ω}_{c}} {R}_{3} \\ = 0.17 M\end{matrix} \qquad Eqn . ( 11 )$$

Since

R₁+2R₂+R₃, Eqn. 12

it follows that R2=5.9 M.

Two intermediate gears (2) are used in order to balance the force exerted on the pinion and to provide redundancy to the mechanism. These two gears are affixed to the hub, which also supports the pinion. They rotate about their own axes and thereby impose a rotation to the outer ring (3) which is in the reverse direction to the rotation of the cylinder (4), which is affixed to the pinion (1)

It is evident that the mechanism may be driven by motors driving either the pinion or either of the secondary gears (2), or all three simultaneously. Furthermore, this system of gears can be located on the opposite end of the hub, providing additional redundancy. Multiple locations for motors to drive the system reduces the power required for any one motor. Once the system is in motion, the power required will be that required to overcome friction in the gears and to maintain a constant rotational speed as conditions change within the torus due to movements of personnel and equipment, or due to other causes which can affect the moment of inertia of the torus and thereby its angular momentum.

The estimated mass of the flywheel (8.4E6 KG) is about one third that of the torus (2.4E7 KG). This added mass to the space station seems to be a reasonable price to pay for its advantages.

### DESCRIPTION OF THE FIGURES

FIG. 1. Photo of rotating space station as conceived by Werhner von Braun to create an artificial gravitational field for astronauts. Model once located in the Air & Space Museum, Washington, D.C. (Prior art)

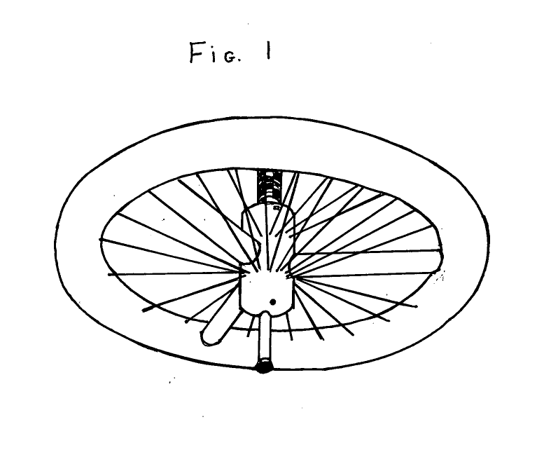

FIG. 2. Schematic of space station of FIG. 1. (Prior art)

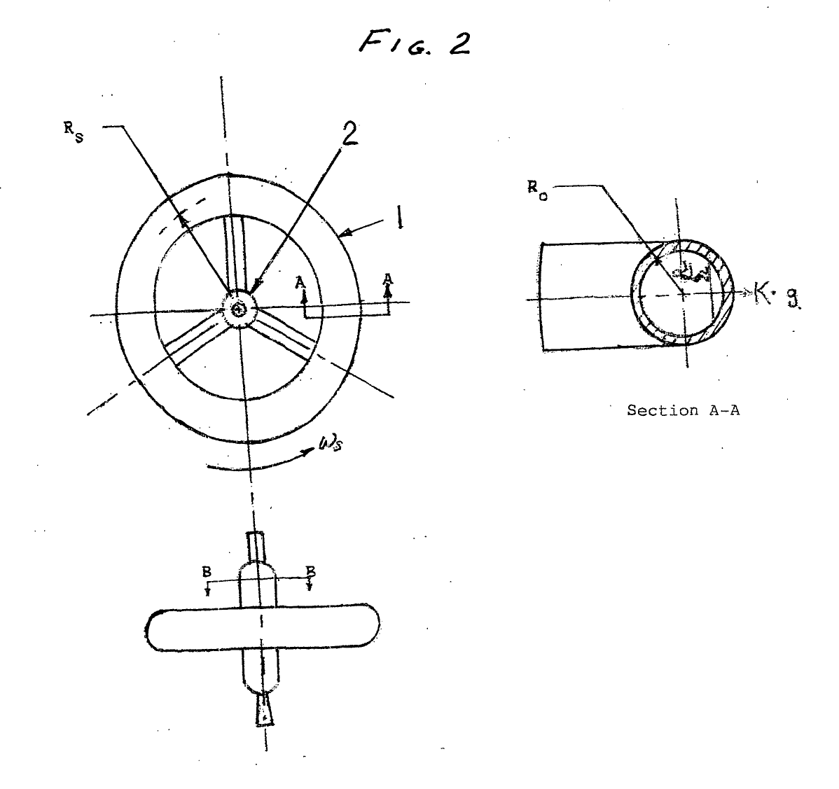

FIG. 3. Cross-section B-B of space station of FIG. 2.

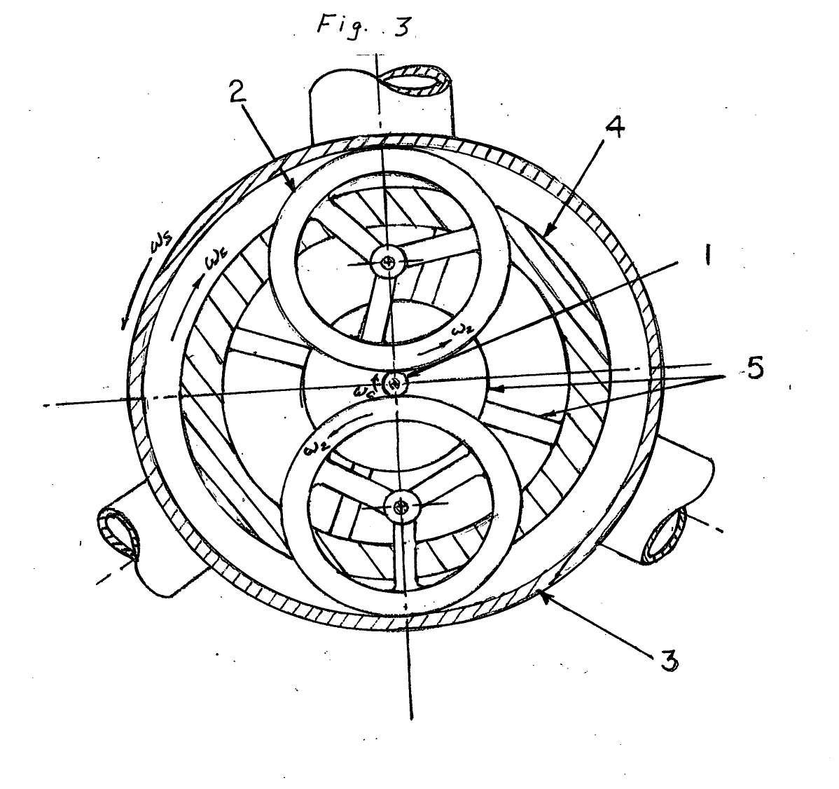

FIG. 4. Pod version of toroidal space station.

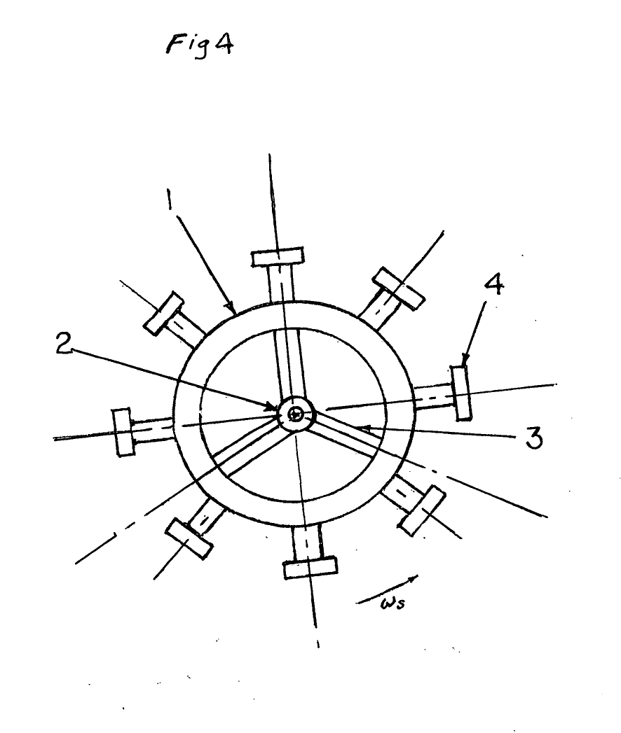

The claims of this invention are:

1. That a mechanism is provided comprising a hub of a toroidal space station, a high density cylinder within the hub, and gears to turn the cylinder in a direction opposite to that of the torus such that the overall angular momentum vector for the station is zero, while creating a variable gravitational field in the torus, for the benefit of astronauts' health and for other purposes.

2. That the mechanism of claim 1, further comprising variable speed motors attached to hubs of gears connecting the center cylinder to the torus, provides for power to operate the system to be supplied by a variety of sources, including solar, nuclear, microwave, or other source, without the need for fuel to operate rocket engines to rotate the torus.

3. That the mechanism of claims 1 and 2 further provides for redundancy in the drive mechanism offering a margin of safety not provided by other inventions addressing the problem of creating an artificial gravitational environment in space, that the level of artificial gravity may be continuously and precisely varied and can exceed that of Earth in preparation for missions to other planets and for docking maneuvers, and provides for ease of orienting the station since precession due to gyroscopic effects is eliminated because the overall angular momentum vector for the station and hub is zero.
